(19) United States
(12) Patent Application Publication
(10) Pub. No.: US 2026/0178159 A1
(43) Pub. Date: Jun. 25, 2026

(54) EVALUATION APPARATUS AND EVALUATION METHOD

(71) Applicant: HITACHI HIGH-TECH CORPORATION, Minato-ku, Tokyo (JP)

(72) Inventors: Katsutoshi MURAMATSU, Tokyo (JP); Nobuaki NAKASU, Tokyo (JP); Kohei SATO, Tokyo (JP)

(21) Appl. No.: 18/847,379

(22) PCT Filed: Aug. 31, 2023
(86) PCT No.: PCT/JP2023/032032

§ 371 Date: Sep. 16, 2024

(51) Int. Cl. G06F 3/0481; G05B 19/4097; G05B 19/418; G06F 3/0488

(52) U.S. Cl. CPC G06F 3/0481; G05B 19/4097; G05B 19/41875; G06F 3/0488

(57) ABSTRACT

An evaluation apparatus and method for evaluating an operation of assembling a processing apparatus includes a data collector and a fraction defective calculator. The data collector acquires gravity information and information indicating an order of motion and assembly for parts for each step in the assembly operation (hereinafter, “an assembling step”), acquires information indicating a task motion performed by an operator in the assembling step, acquires information indicating a surface of interest in each of the parts, and acquires information indicating a positional relation between a foreign object source and the part in the assembling step. The fraction defective calculator calculates a foreign-object-factored fraction defective percentage indicating a risk that a foreign object from the foreign object source adheres to the surface of interest due to the task motion, based on the gravity information, the assembly order information, the task motion information and the relative position information.

### TECHNICAL FIELD

The present invention relates to an evaluation apparatus and an evaluation method.

### BACKGROUND ART

In the related art, methods have been developed for reducing maintenance operation time by estimating a maintenance operation time from facility design and a maintenance operation procedure at a facility design stage and improving the design and procedure.

Patent Literature 1 provides a program capable of improving accuracy of an estimated value of an assembly time calculated in a simulation, and the following contents are disclosed as a program, an assembly time calculation method, and an assembly time calculation device. “A program for calculating an assembly time of a product by simulation causes an input unit 1302 to acquire an animation data for displaying a procedure of an assembly operation of the product on a display unit by animation, causes a change point detection unit 1310 to detect a change in viewpoint of the animation from the acquired animation data, and causes a standard time calculation unit 1311 to calculate an estimated value of the assembly time of the product based on the detected change in viewpoint of the animation.”

Patent Literature 2 provides an assemblability evaluation system that enables easy input for evaluation by performing input to implement a function of extracting a data to be used for evaluation from a three-dimensional CAD data and using the data in other processes, subsequent processes, or auxiliary processes, and that enables the functions to be actually used. The following contents are disclosed as an assemblability evaluation method, an assemblability evaluation system, and an assemblability evaluation program. “The system captures a three-dimensional CAD data, accepts an operation from a user to create animation, records a motion of a part caused by the accepted operation, creates an evaluation data based on the motion, and substitutes the created evaluation data into a prepared evaluation formula to obtain an evaluation result. Therefore, the input required to be performed by the user lies in creating assembly animation. Once the animation is created, the evaluation data can be automatically created and the evaluation result can be obtained, greatly reducing the amount of input of the user.”

### CITATION LIST

### Patent Literature

Patent Literature 1: JP2014-182557A
Patent Literature 2: JP2007-200082A

### SUMMARY OF INVENTION

### Technical Problem

The maintenance operation time of a semiconductor processing apparatus can be estimated using the sum of a wet operation time, a leak reworking time, and a foreign object reworking time. The wet operation time is a time required for “disassembly, cleaning, and assembly” in which mainly a chamber in which the processing of a wafer is performed is disassembled, a foreign object generated in reaction processing is cleaned, and then the chamber is assembled again. The leak reworking time is a time required for performing the assembly again when failing to pass a leak test after the wet operation until the leak test is passed. The foreign object reworking time is a time required for performing the wet operation and the leak test again when failing to pass a foreign object test after passing the leak test, until the foreign object test is passed. As described above, since the maintenance operation time is affected by the wet operation time, a leak occurrence rate, and a foreign-object-factored fraction defective, a method of estimating in advance the wet operation time, the leak occurrence rate, and the foreign-object-factored fraction defective is required.

Patent Literature 1 discloses a method of estimating an assembly operation time based on design data, and the method can estimate a wet operation time. Patent Literature 2 discloses a method of estimating assemblability (fraction defective) based on design data, and the method can estimate a leak occurrence rate. However, in Patent Literature 1 and Patent Literature 2, studies on a foreign-object-factored fraction defective have not been conducted sufficiently.

Therefore, an object of the invention is to provide a technique for estimating a foreign-object-factored fraction defective.

### Solution to Problem

In order to solve the above problem, a representative evaluation apparatus according to the invention is provided that is an evaluation apparatus for evaluating an assembly operation of assembling a processing apparatus including a plurality of parts, the evaluation apparatus including: a data collector; and a fraction defective calculator. The data collector acquires a gravity information indicating a gravity direction, acquires an assembly order information indicating an order of motion and assembly performed to each of the plurality of parts for each step included in the assembly operation (hereinafter, referred to as an assembling step), acquires a task motion information indicating a task motion performed by an operator in the assembling step, acquires a surface-of-interest information indicating a surface of interest in each of the plurality of parts, and acquires a relative position information indicating a positional relation between a foreign object source and the part in the assembling step. The fraction defective calculator calculates a foreign-object-factored fraction defective indicating a risk that a foreign object from the foreign object source adheres to the surface of interest due to the task motion, based on the gravity information, the assembly order information, the task motion information and the relative position information.

### Advantageous Effects of Invention

According to the invention, it is possible to estimate a foreign-object-factored fraction defective.

Problems, configurations, and effects other than those described above will be made clear by the following description of embodiments for carrying out the invention.

### BRIEF DESCRIPTION OF DRAWINGS

FIG. 1 is a diagram illustrating a display example shown by an evaluation apparatus according to an embodiment.

FIG. 2 is a diagram illustrating an example of a configuration of the evaluation apparatus according to the embodiment.

FIG. 3 is a flowchart of processing of calculating a foreign-object-factored fraction defective performed by the evaluation apparatus.

FIG. 4 is a diagram illustrating an example of an assembly order information, a task motion information, and a surface-of-interest information.

FIGS. 5A and 5B are diagrams illustrating an example of a relative position information.

FIG. 6 is a table illustrating an example of a foreign-object-factored fraction defective DB.

FIG. 7 illustrates an example of a foreign-object-factored fraction defective table.

FIGS. 8A-8C are diagrams illustrating an extraction method of extracting a measure policy from the foreign-object-factored fraction defective table.

FIG. 9 is a diagram schematically illustrating a scene of a step of assembling a child part into a mother part in a wet operation.

### DESCRIPTION OF EMBODIMENTS

Hereinafter, embodiments of the invention will be described with reference to the drawings. The invention is not limited to the embodiments. In the description of the drawings, the same portions are denoted by the same reference signs.

### (Cause of Foreign-Object-Caused Defect)

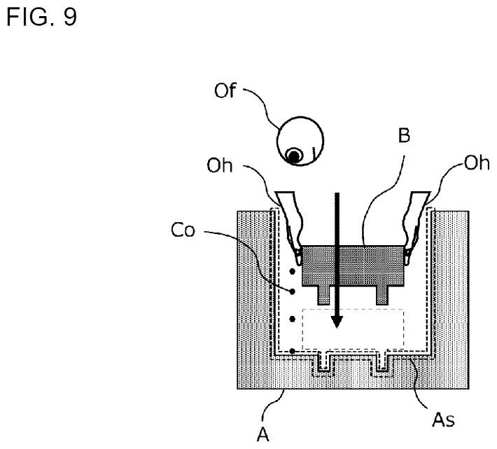

A cause of a foreign-object-caused defect will be described with reference to FIG. 9. FIG. 9 is a diagram schematically illustrating a scene of a step of assembling a child part into a mother part in a wet operation.

FIG. 9 illustrates a motion of assembling a child part B into a mother part A. The mother part A indicates a part to which a part is attached. The child part B refers to a part moved by an operator. For example, in a case where the mother part A and the child part B are parts constituting a semiconductor processing apparatus, the mother part A corresponds to a chamber or the like, and the child part B corresponds to a sample stage or the like disposed in the chamber. The child part B is lifted by the operator's hands and is disposed inside the mother part A.

An arrow indicates a vertically downward direction and indicates a gravity direction. In an assembling step, since the operator moves to look into the inside of the cylindrical mother part A, the operator's face Of may be located above the mother part A. If a foreign object is generated from the face Of, it is assumed that a foreign object Co moves downward in a vertical direction and reaches a surface of a surface portion As of the mother part A, which spreads in a direction perpendicular to the vertical direction.

The child part B is transferred to an installation position in the mother part A while being held by hands Oh of the operator. There is a possibility that the hand Oh of the operator contacts an inner side of the mother part A in addition to the child part B. It is assumed that the hand Oh of the operator comes into contact with a surface of the surface portion As, which spreads in a direction parallel to the vertical direction, and the foreign object moves from the hand Oh to the surface portion As.

As described above, it is conceivable that a foreign object from the body and the clothes of the operator adheres to a part in the assembling process. When estimating the cause of the foreign-object-caused defect, it is necessary to consider the adhesion of a foreign object from a part other than an assembly target part and the influence of a physical motion of the operator at the time of assembly, in addition to a foreign object originally adhering to the assembly target part.

### (Display Example of Evaluation Apparatus)

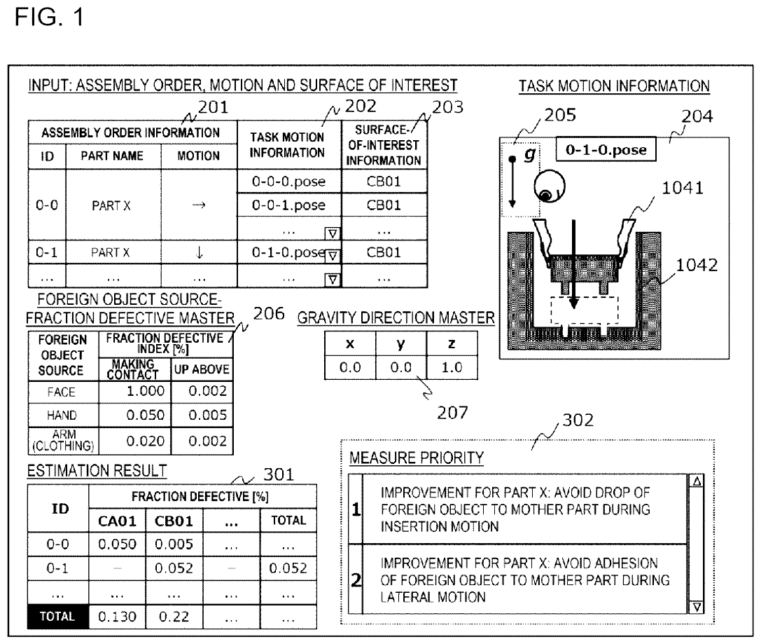

FIG. 1 is a diagram illustrating a display example shown by an evaluation apparatus according to an embodiment. As will be described later, the evaluation apparatus includes an input I/F (interface) and an output I/F. The evaluation apparatus has a display function implemented by the input I/F and the output I/F.

The input I/F and the output I/F perform display including an assembly order input portion 201, a task motion input portion 202, a surface-of-interest input portion 203, a gravity direction display portion 205, a relative position display portion 204, a fraction defective setting portion 206, a gravity input portion 207, a result display portion 301, and a measure display portion 302.

The assembly order input portion 201 indicates a set assembly order information and receives an input operation of a user with respect to the assembly order information. The assembly order information will be described later.

An input UI (user interface) can be appropriately set in the assembly order input portion 201. For example, by operating a drill-down menu shown in a cell, the user can edit a numerical value or text indicated in the cell.

The task motion input portion 202 indicates a set task motion information and receives an input operation of the user with respect to the task motion information. The task motion information will be described later.

The surface-of-interest input portion 203 indicates a portion (surface) of a part for which evaluation as to whether a foreign object adheres is performed in the evaluation apparatus.

The relative position display portion 204 indicates a relative positional relation between a foreign object source and a part, in each motion of the operator.

The gravity direction display portion 205 indicates a direction of gravity acting on the foreign object source and the part shown in the relative position display portion 204.

The fraction defective setting portion 206 indicates a relation between a foreign object source and a fraction defective associated with the foreign object source. The fraction defective setting portion 206 indicates a fraction defective index held in advance in a foreign-object-factored fraction defective DB 7 to be described later. Further, the fraction defective setting portion 206 receives an input operation of the user with respect to the fraction defective index. The foreign-object-factored fraction defective DB 7 will be described later.

The gravity input portion 207 indicates an information defining the gravity direction (hereinafter also referred to as a “gravity information”). The gravity input portion 207 receives an input operation of the user with respect to the gravity information. The gravity direction in the gravity information set via the gravity input portion 207 is displayed as an arrow in the gravity direction display portion 205.

The result display portion 301 displays a result of estimating the foreign-object-factored fraction defective.

The measure display portion 302 shows a measure of a task motion for the operator. As a measure ranking first in priority, “improvement for part X: avoid drop of foreign object to mother part during insertion motion” is displayed. As a measure ranking second in priority, “improvement for the part X: avoid adhesion of foreign object to mother part during lateral motion” is displayed.

The measure display portion 302 can also display other measures. For example, a scroll bar may be provided at a side portion of the measure display portion 302, and a plurality of measures can be displayed when the user operates the scroll bar.

In FIG. 1, numerical values and texts are shown in a plurality of cells. The user can selects a cell to edit the numerical value and text indicated in the cell. Such display and editing can be implemented by using, as the input I/F and the output I/F, a display device such as a display and an input device such as a keyboard and a mouse. An input and output device such as a touch panel may be used as the input I/F and the output I/F. The I/F is not limited to a display device, and a sound output device or the like may be used.

### (Configuration of Evaluation Apparatus)

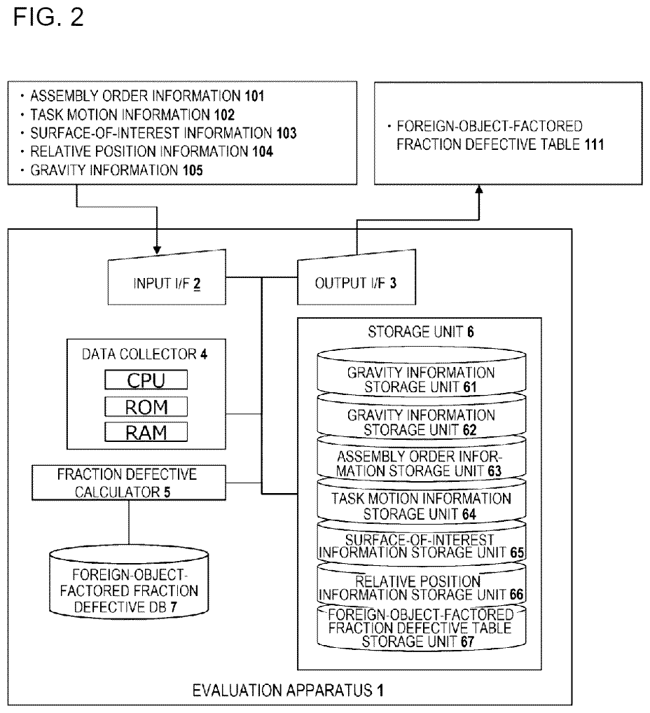

FIG. 2 is a diagram illustrating an example of a configuration of the evaluation apparatus according to the embodiment. An evaluation apparatus 1 evaluates an assembly operation of assembling a processing apparatus including a plurality of parts. The evaluation apparatus 1 includes a data collector 4 and a fraction defective calculator 5.

The data collector 4 acquires a gravity information indicating a gravity direction, acquires an assembly order information indicating an order of motion and assembly performed to each of the plurality of parts for each step included in the assembly operation (hereinafter, referred to as an assembling step), acquires a task motion information indicating a task motion performed by an operator in the assembling step, acquires a surface-of-interest information indicating a surface of interest in each of the plurality of parts, and acquires a relative position information indicating a positional relation between a foreign object source and the part in the assembling step.

Based on the gravity information, the assembly order information, the task motion information, and the relative position information, the fraction defective calculator 5 calculates a foreign-object-factored fraction defective indicating a risk that a foreign object from the foreign object source adheres to the surface of interest due to the task motion. Hereinafter, details will be described.

The evaluation apparatus 1 includes an input I/F 2, an output I/F 3, the data collector 4, the fraction defective calculator 5, a storage unit 6, and the foreign-object-factored fraction defective DB 7.

As illustrated in FIG. 1, the input I/F 2 shows each information to the user of the evaluation apparatus 1, and receives an input operation of the user.

The input I/F 2 receives an information such as an assembly order information 101, a task motion information 102, a surface-of-interest information 103, a relative position information 104, and a gravity information 105, and an input operation by the user for setting the information.

The assembly order information 101 indicates an order of motion and assembly performed to each of the plurality of parts for each assembling step included in the assembly operation. The task motion information 102 indicates a motion of the user in the assembling step. The surface-of-interest information 103 indicates a surface of interest of each of the plurality of parts. The assembly order information 101, the task motion information 102, and the surface-of-interest information 103 are respectively set via the assembly order input portion 201, the task motion input portion 202, and the surface-of-interest input portion 203 as illustrated in FIG. 1.

The relative position information 104 indicates a positional relation between a foreign object source and the part in the assembling step. The relative position information 104 is shown in the relative position display portion 204 in FIG. 1.

The gravity information 105 indicates a gravity direction. The gravity information 105 is shown in the gravity direction display portion 205 in FIG. 1. The gravity information 105 is set via the gravity input portion 207. With the gravity input portion 207, for example, the magnitude of gravity can be set using three axes of xyz.

Although a case where the above-described information is set via the input I/F 2 has been described, the invention is not limited thereto. The above-described information may be set in advance in the storage unit 6 described later, and the information set in advance may be shown to the user. Further, it is also possible to extract the above-described information from an assembly operation actually performed by the operator using an imaging device, a body sensor, or the like, and to show the information to the user in the input I/F 2.

The data collector 4 acquires the gravity information 105, the assembly order information 101, the task motion information 102, the surface-of-interest information 103, and the relative position information 104. The data collector 4 includes, for example, at least one of a CPU, a ROM, and a RAM.

The fraction defective calculator 5 calculates a foreign-object-factored fraction defective of a surface of interest based on the gravity information, the assembly order information, the task motion information, and the relative position information. A relation between the surface of interest and the foreign-object-factored fraction defective is calculated for each step included in an assembly order and for each surface of interest. The fraction defective calculator 5 creates a foreign-object-factored fraction defective table 111 indicating a plurality of relations.

Although the data collector 4 and the fraction defective calculator 5 are described as having different configurations, the present disclosure is not limited thereto. The fraction defective calculator 5 may be provided in the configuration of the data collector 4.

The output I/F 3 shows the foreign-object-factored fraction defective table 111 to the user. The result display portion 301 in FIG. 1 shows information included in the foreign-object-factored fraction defective table 111. The output I/F 3 displays the measure display portion 302 in FIG. 1.

The storage unit 6 stores an information input via the input I/F 2 and an information calculated by the fraction defective calculator 5. In the storage unit 6, gravity information storage units 61 and 62 store the gravity information 105. An assembly order information storage unit 63 stores the assembly order information 101. A task motion information storage unit 64 stores the task motion information 102. A surface-of-interest information storage unit 65 stores the surface-of-interest information 103. A relative position information storage unit 66 stores the relative position information 104. A foreign-object-factored fraction defective table storage unit 67 stores the foreign-object-factored fraction defective table 111.

Although a case where a storage unit is provided for each information has been described, the invention is not limited thereto. The storage unit may be implemented by one piece of hardware, and a plurality of information may be stored in one storage unit.

A foreign-object-factored fraction defective DB 7 holds a data indicating a relation between the foreign object source and the fraction defective shown in the fraction defective setting portion 206.

The configuration of the evaluation apparatus 1 may be implemented by hardware or may be implemented by information processing resources provided by cloud services.

Further, although a case where a foreign-object-factored fraction defective is calculated for a semiconductor processing apparatus will be described, the present disclosure is not limited to the case of the semiconductor processing apparatus.

### (Processing of Calculating Foreign-Object-Factored Fraction Defective)

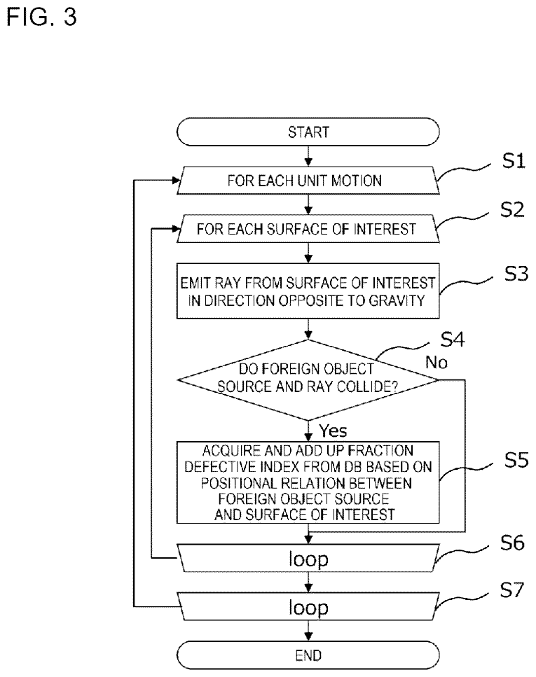

FIG. 3 is a flowchart of processing of calculating a foreign-object-factored fraction defective performed by the evaluation apparatus.

The foreign-object-factored fraction defective is calculated for each unit motion (step S1 to step S7) and for each surface of interest (step S2 to step S6). The unit motion is a motion obtained by subdividing motions in an assembly operation based on a predetermined criterion, and means a motion distinguished to calculate a foreign-object-factored fraction defective thereof. Although a case where a task motion included in the task motion information 102 is regarded as a unit motion will be described below, the present disclosure is not limited thereto. An analysis method of the motion in the assembly operation can be appropriately set.

For each task motion and each surface of interest, the data collector 4 acquires the gravity information 105, the task motion information 102, the surface-of-interest information 103, and the relative position information 104 that are required to calculate the foreign-object-factored fraction defective.

Subsequently, the fraction defective calculator 5 determines whether the positional relation between a foreign object source and a part is a predetermined positional relation or another positional relation other than the predetermined positional relation. Hereinafter, details will be described.

In the determination of the predetermined positional relation, ray tracing of determining whether a straight line extending perpendicularly from the surface of interest of the part collides with the foreign object source is used. Specifically, the fraction defective calculator 5 emits a ray from the surface of interest in a direction opposite to the gravity direction indicated by the gravity information 105 (step S3). For example, when the part is represented by a polygon, a half line is extended from the center of gravity of each of facets (triangular surfaces) constituting the surface of interest to the side opposite to the gravity.

The fraction defective calculator 5 determines whether the foreign object source and the ray collide with each other (step S4). Specifically, it is determined whether the half line extending perpendicularly from the surface of interest collides with the foreign object source. In the case of a collision, the fraction defective calculator 5 acquires and adds up the fraction defective index from the DB (database) based on the positional relation between the foreign object source and the surface of interest (step S5). Examples of the foreign object source include the face and hands of the operator and a tool handled by the operator. Examples of the positional relation include a case where the foreign object source is in contact with the surface of interest (a case where the half line set between the foreign object source and the surface of interest has a length equal to or smaller than a predetermined length), and a case where the foreign object source is located up above the surface of interest (a case where the foreign object source is not in contact with the surface of interest but the foreign object source is present at a position in an opposite direction from the gravity direction of the surface of interest and the half line extending from the surface of interest reaches the foreign object source). Although a case where the gravity direction and the direction perpendicular to the surface of interest are parallel has been described, the present disclosure is not limited thereto. The present disclosure can also be applied to a case where the gravity direction and the direction perpendicular to the surface of interest are not parallel.

### DETAILS OF INFORMATION

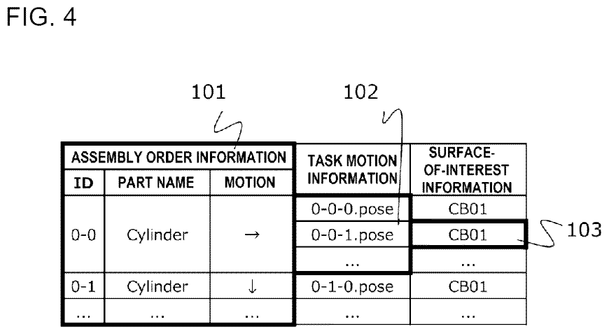

FIG. 4 is a diagram illustrating an example of the assembly order information 101, the task motion information 102, and the surface-of-interest information 103. FIG. 4 shows the information in a display format shown in the assembly order input portion 201, the task motion input portion 202, and the surface-of-interest input portion 203 in FIG. 1.

In the assembly order information 101, an item “ID” indicates an assembling step included in an assembly operation. An item “part name” indicates a part operated by the operator in each assembling step. The part name mainly indicates a child part. An item “motion” indicates motion elements determined in analyzing the assembly operation. A symbol “\” means moving the child part in a lower direction (in the gravity direction), and a symbol “_” means moving the child part laterally. In an assembling step of ID 0-0, a cylinder (Cylinder) is moved laterally. In an assembling step of ID 0-1, the cylinder is moved in the lower direction (insertion motion). The assembling step of ID 0-1 is performed following the assembling step of ID 0-0, and the assembling steps are arranged in time series.

The task motion information 102 indicates the positional relation between the foreign object source and the part in the assembling step, and is a time series data divided by a predetermined time length. For example, the task motion information 102 is a 3D simulation data covering the start to the end of the assembling step or a data obtained by dividing the 3D simulation data by a fixed time length. Here, the assembling step of ID 0-0 is indicated by divided data in a predetermined format, that is, “0-0-0. pose, 0-0-1. pose, . . . ” The assembling step of ID 0-1 is indicated by data, that is, “0-1-0. pose”.

The surface-of-interest information 103 indicates a surface for which foreign object adhesion is evaluated. The surface of interest is designated by the user. The surface of interest may be a surface selected by the evaluation apparatus 1. The surface of interest may be defined as a cleaning surface, which is a surface that requires a predetermined degree of cleanliness, and the data collector 4 may extract the cleaning surface based on a dimension data of a semiconductor processing apparatus in a state of being assembled and a cleaning surface determining condition that is a condition for determining the cleaning surface. For example, the cleaning surface determining condition allows for determining whether a cleaning surface is a surface to which a flag or the like is set in advance in the dimension data of the part. Here, CB01 is extracted as the surface of interest. CB01 indicates a surface of a mother part in the assembly operation. The surface of interest is not limited to a surface of a mother part, and may be a surface of a child part. A plurality of surfaces may be extracted as the surface of interest.

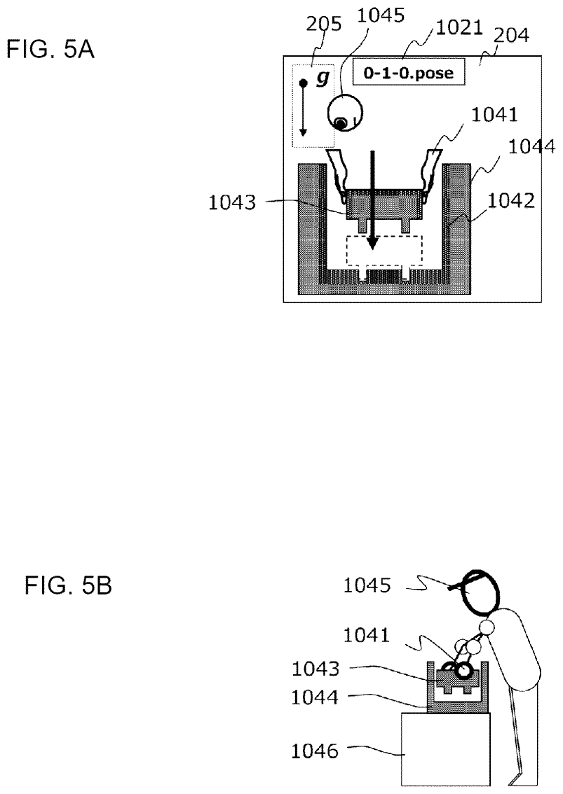

FIGS. 5A and 5B are diagrams illustrating an example of the relative position information 104. FIG. 5A shows the information in a display format shown in the relative position display portion 204. A name column 1021 indicates a name of a displayed data in the task motion information 102. In the relative position display portion 204, the gravity information 105 set in the gravity input portion 207 is also shown, and the gravity direction is indicated by an arrow. FIG. 5A schematically shows a relative positional relation between a hand 1041 of the operator, a face 1045 of the operator, a child part 1043, a mother part 1044, and a surface of interest 1042. Since the hand 1041 and the face 1045 are particular parts serving as a foreign object source, the hand 1041 and the face 1045 are extracted from the element constituting the operator.

FIG. 5A is a schematic display, and the data collector 4 calculates a relative positional relation between the child part 1043, the mother part 1044, and the foreign object source based on the assembly order information 101, the task motion information 102, and the surface-of-interest information 103. FIG. 5B is a diagram illustrating an example of the task motion information 102. The task motion information 102 is a 3D simulation data and includes the hand 1041 and the face 1045 of the operator, the child part 1043, and the mother part 1044 (disposed on a work table 1046). The data collector 4 calculates the relative position information 104 based on a position information of the body of the operator, the part to be assembled, the surface of interest, and the like in the assembling step of the assembly operation.

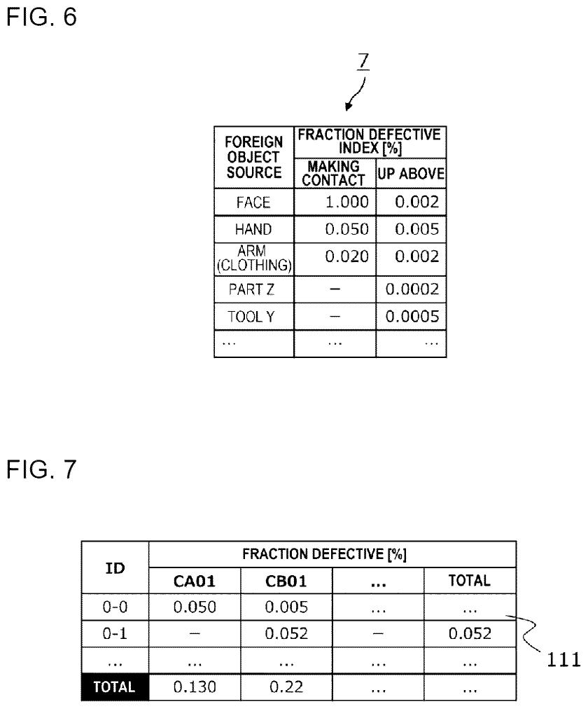

The evaluation apparatus 1 further includes a database in which a fraction defective index is defined for each positional relation, and the fraction defective calculator 5 calculates the foreign-object-factored fraction defective for each surface of interest based on the fraction defective index. FIG. 6 is a table illustrating an example of the foreign-object-factored fraction defective DB 7. The foreign-object-factored fraction defective DB 7 defines, for each relative positional relation between the part and the foreign object source, a fraction defective index indicating a foreign object adhesion risk caused by each foreign object source. An item “foreign object source” indicates a cause of occurrence of a foreign object. An item “fraction defective index” indicates a numerical value used for calculation of a foreign-object-factored fraction defective in a case of performing a foreign object test of the semiconductor processing apparatus. The fraction defective index is defined when there is a predetermined positional relation between the foreign object source and the part. Items “making contact” and “up above” indicate relative positional relations between the foreign object source and the part. The item “making contact” is a case where the foreign object source and the part come into contact with each other. The item “up above” is a case where the foreign object source is present on an upper side of the part. The term “upper side” refers to a direction opposite to the gravity direction when a part is used as a reference. A method of calculating the foreign-object-factored fraction defective of the entire assembly operation will be described later.

A foreign object source “face” refers to the face of the operator. When the face makes contact with the part, the fraction defective index thereof is 1.000%. When the face is up above the part, the fraction defective index thereof is 0.002%. A foreign object source “hand” refers to the hand of the operator. When the hand makes contact with the part, the fraction defective index thereof is 0.050%. When the hand is up above the part, the fraction defective index thereof is 0.005%. A foreign object source “arm (clothing)” refers to the arm of the operator. When the arm makes contact with the part, the fraction defective index thereof is 0.020%. When the arm is up above the part, the fraction defective index thereof is 0.002%.

A foreign object source “part Z” refers to a part to which a foreign object is adhered. For example, in a case of fixing a child part to a mother part with a screw that is not properly treated, the screw corresponds to the part Z. Although a case where such a screw makes contact with a part is not assumed, a case where the screw passes up above the mother part during transport of the screw is assumed. The fraction defective index is set to 0.0002%.

A foreign object source “tool Y” refers to a tool to which a foreign object is adhered. For example, in a case of fixing a child part to a mother part with a wrench that is not properly treated, the wrench corresponds to the tool Y. Although a case where such a wrench makes contact with a part is not assumed, a case where the wrench passes up above the mother part during transport of the wrench is assumed. The fraction defective index is set to 0.0005%.

Although the definitions of the foreign object source and the fraction defective index have been described, the present disclosure is not limited thereto. It is also possible to adopt other foreign object sources and fraction defective indexes. Although the cases of “making contact” and “up above” have been described as the predetermined positional relation, the fraction defective index may be defined according to other positional relations. The part and tool may be other parts and tools used in the assembly operation in addition to a screw and a wrench.

FIG. 7 illustrates an example of the foreign-object-factored fraction defective table 111. The foreign-object-factored fraction defective table 111 indicates information displayed in the result display portion 301.

The foreign-object-factored fraction defective table 111 shows a result of calculating a relation between the surface of interest and the fraction defective for each assembling step. The surface of interest indicates a surface of a part whose positional relation with a foreign object is determined to be “making contact” or “up above”. In the assembling step of ID 0-0, the foreign-object-factored fraction defective for a surface of interest CA01 is calculated to be 0.050, and a foreign-object-factored fraction defective for a surface of interest CB01 is calculated to be 0.005. In the assembling step of ID 0-1, the foreign-object-factored fraction defective for the surface of interest CB01 is calculated to be 0.052.

The fraction defective calculator 5 sums up or combines by multiplication foreign-object-factored fraction defectives of respective surfaces of interest in the same assembling step. In the step of ID 0-1, the surface of interest is the CB01 alone, and the foreign-object-factored fraction defective of 0.052% of the surface of interest CB01 is described in an item “total” as the foreign-object-factored fraction defective of the assembling step of ID 0-1. In this way, by calculating the foreign-object-factored fraction defective focusing on the assembling step, it is possible to evaluate the occurrence of a foreign object by analyzing the assembly operation for each assembling step.

Further, regarding the same surface of interest, the fraction defective calculator 5 sums up or combines by multiplication its foreign-object-factored fraction defectives of respective surfaces of interest in the assembly operation. A fraction defective of 0.130% is shown in a total column of the surface of interest CA01, and a fraction defective of 0.22% is shown in a total column of the surface of interest CB01. In this way, by calculating the foreign-object-factored fraction defective focusing on the surface of interest, the part having the highest foreign object adhesion risk in the assembly operation can be extracted, and the foreign-object-factored fraction defective can be utilized in the improvement of the task motion.

Here, a specific example of the calculation of the foreign-object-factored fraction defective will be described with reference to the relative position information 104 shown in FIG. 5A and the foreign-object-factored fraction defective DB 7 shown in FIG. 6. As shown in FIG. 5A, the face 1045 and the hand 1041 are present as a foreign object source.

The hand 1041 is in contact with an upper surface (a surface in a direction perpendicular to the gravity direction) of the child part 1043. The face 1045 is located up above. Therefore, the foreign-object-factored fraction defective of the upper surface of the child part 1043 is calculated to be 0.050% (fraction defective index in the case where the hand makes contact)+0.002% (fraction defective index in the case where the face is up above)=0.052%.

Further, the hand 1041 and the face 1045 are located with respect to a bottom surface (a surface in a direction perpendicular to the gravity direction) of the mother part 1044. Therefore, the foreign-object-factored fraction defective of the bottom surface of the mother part 1044 is calculated to be 0.002% (fraction defective index in the case where the face is up above)+0.005% (fraction defective in the case where the hand is up above)=0.007%.

The sum-up of the fraction defective indexes and the multiplication of the fraction defective indexes may be appropriately set. For example, when there is a relevance between task motions as in a case where a child part is disposed to a mother part by a downward motion (insertion motion) and then the child part is caused to roll and fixed in a fitting groove, it is conceivable to evaluate the foreign object adhesion risk by combining, by multiplication, fraction defective indexes in respective task motions. Further, when there is an effective task motion during which a foreign object is likely to occur, the sum-up may be performed after multiplying the fraction defective index by a weight.

### (Priority of Measure Policy)

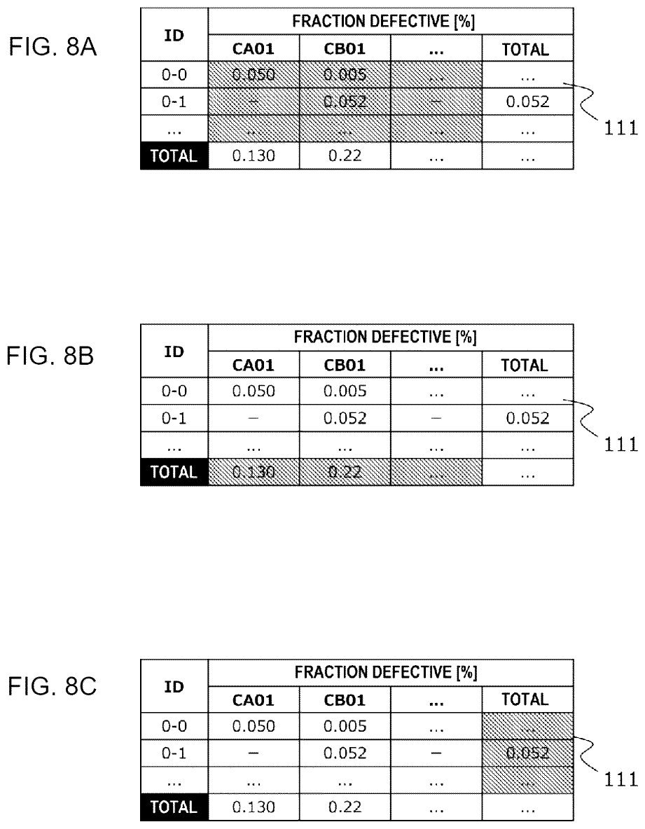

The measure display portion 302 displays a measure policy with a priority to the operator. A method of setting the priority will be described with reference to FIGS. 8A-8C.

FIGS. 8A-8C are diagrams illustrating an extraction method of extracting a measure policy from the foreign-object-factored fraction defective table 111. Based on the foreign-object-factored fraction defective, the fraction defective calculator 5 extracts an assembling step to be improved from assembling steps included in the assembly order information and assigns a priority thereto.

FIG. 8A is a diagram illustrating a first extraction method. The first extraction method focuses on a task motion that affects the fraction defective. The fraction defective calculator 5 extracts an ID associated with a cell having the largest foreign-object-factored fraction defective from a table (oblique line display) of the surface of interest and the ID in the foreign-object-factored fraction defective table 111. The fraction defective calculator 5 acquires a part name and a motion corresponding to the extracted ID with reference to the assembly order information 101, and acquires a surface of interest corresponding to the extracted ID with reference to the surface-of-interest information 103. The fraction defective calculator 5 displays the acquired part name, motion, and surface of interest in the measure display portion 302.

FIG. 8B is a diagram illustrating a second extraction method. The second extraction method focuses on a surface of interest that affects the fraction defective. The fraction defective calculator 5 extracts a surface of interest associated with a cell having the largest fraction defective from columns (oblique line display) of total values of the foreign-object-factored fraction defective calculated for each surface of interest in the foreign-object-factored fraction defective table 111. The fraction defective calculator 5 extracts an ID having the largest foreign-object-factored fraction defective from the extracted surface of interest and the column of ID. The fraction defective calculator 5 acquires a part name and a motion corresponding to the extracted ID with reference to the assembly order information 101, and acquires the surface of interest corresponding to the extracted ID with reference to the surface-of-interest information 103. The fraction defective calculator 5 displays the acquired part name, motion, and surface of interest in the measure display portion 302.

FIG. 8C is a diagram illustrating a third extraction method. The third extraction method focuses on an assembling step that affects the fraction defective. The fraction defective calculator 5 extracts an ID associated with a cell having the largest fraction defective from a column (oblique line display) of total values of the foreign-object-factored fraction defective calculated for each ID in the foreign-object-factored fraction defective table 111. The fraction defective calculator 5 extracts a surface of interest having the largest foreign-object-factored fraction defective from the extracted ID and the row of surface of interest. The fraction defective calculator 5 acquires a part name and a motion corresponding to the extracted ID with reference to the assembly order information 101. The fraction defective calculator 5 displays the extracted surface of interest and the acquired part name and motion in the measure display portion 302.

As described above, since a factor that greatly affects the foreign-object-factored fraction defective is extracted separately in the three perspectives of the task motion, the surface of interest, and the assembling step, it is possible to indicate a task guideline such as a task manual, with which the foreign object adhesion risk is reduced, when designing the assembly operation.

### Operational Effects

As described above, according to the present disclosure, it is possible to estimate a foreign-object-factored fraction defective by setting an information on a task motion, an information on a foreign object source, and the like. It is possible to design an assembly operation that reduces the foreign object adhesion risk and minimizes the maintenance operation time of the semiconductor processing apparatus.

Although embodiments of the invention have been described above, the invention is not limited to the embodiments described above, and various changes can be made without departing from the gist of the invention.

Aspects that may be contents of the invention will be described below, but are not limited thereto.

### (Aspect 1)

An evaluation apparatus for evaluating an assembly operation of assembling a processing apparatus including a plurality of parts, the evaluation apparatus including:
a data collector; and
a fraction defective calculator, in which
the data collector
   acquires a gravity information indicating a gravity direction,
   acquires an assembly order information indicating an order of motion and assembly performed to each of the plurality of parts for each step included in the assembly operation (hereinafter, referred to as an assembling step),
   acquires a task motion information indicating a task motion performed by an operator in the assembling step,
   acquires a surface-of-interest information indicating a surface of interest in each of the plurality of parts, and
   acquires a relative position information indicating a positional relation between a foreign object source and the part in the assembling step, and
the fraction defective calculator calculates a foreign-object-factored fraction defective indicating a risk that a foreign object from the foreign object source adheres to the surface of interest due to the task motion, based on the gravity information, the assembly order information, the task motion information and the relative position information.

### (Aspect 2)

The evaluation apparatus according to aspect 1, in which
the task motion information indicates the positional relation in the assembling step, and is a time series data divided by a predetermined time length.

### (Aspect 3)

The evaluation apparatus according to aspect 1 or 2, in which
the surface of interest is a cleaning surface that is a surface requiring a predetermined degree of cleanliness.

### (Aspect 4)

The evaluation apparatus according to any one of aspects 1 to 3, in which
the data collector extracts the cleaning surface based on a dimension data of the processing apparatus in a state of being assembled and a cleaning surface determination condition that is a condition for determining the cleaning surface.

### (Aspect 5)

The evaluation apparatus according to any one of aspects 1 to 4, further including:
a database in which a fraction defective index is defined for each positional relation, in which
the fraction defective calculator calculates the foreign-object-factored fraction defective based on the fraction defective index.

### (Aspect 6)

The evaluation apparatus according to any one of aspects 1 to 5, in which
the fraction defective calculator determines whether the positional relation is a predetermined positional relation or another positional relation other than the predetermined positional relation.

### (Aspect 7)

The evaluation apparatus according to any one of aspects 1 to 6, in which
in the determination of the predetermined positional relation, ray tracing is used to determine whether a straight line extending perpendicularly from the surface of interest of the part collides with the foreign object source.

### (Aspect 8)

The evaluation apparatus according to any one of aspects 1 to 7, in which
the fraction defective calculator sums up or combines by multiplication foreign-object-factored fraction defectives of respective surfaces of interest in a same assembling step.

### (Aspect 9)

The evaluation apparatus according to any one of aspects 1 to 8, in which
the fraction defective calculator sums up or combines by multiplication foreign-object-factored fraction defectives of respective surfaces of interest in the assembly operation for a same surface of interest.

### (Aspect 10)

The evaluation apparatus according to any one of aspects 1 to 9, in which
based on the foreign-object-factored fraction defective, the fraction defective calculator extracts an assembling step to be improved from assembling steps included in the assembly order information and assigns a priority to the assembling step.

### (Aspect 11)

An evaluation method for evaluating an assembly operation of assembling a processing apparatus including a plurality of parts, the evaluation method including:
acquiring a gravity information indicating gravity direction;
acquiring an assembly order information indicating an order of motion and assembly performed to each of the plurality of parts for each step included in the assembly operation (hereinafter, referred to as an assembling step);
acquiring a task motion information indicating a task motion performed by an operator in the assembling step;
acquiring a surface-of-interest information indicating a surface of interest in each of the plurality of parts;
acquiring a relative position information indicating a positional relation between a foreign object source and the part in the assembling step; and
calculating a foreign-object-factored fraction defective indicating a risk that a foreign object from the foreign object source adheres to the surface of interest due to the task motion, based on the gravity information, the assembly order information, the task motion information and the relative position information.

### REFERENCE SIGNS LIST

1: evaluation apparatus
2: input I/F
3: output I/F
4: data collector
5: fraction defective calculator
6: storage unit
61: gravity information storage unit
62: gravity information storage unit
63: assembly order information storage unit
64: task motion information storage unit
65: surface-of-interest information storage unit
66: relative position information storage unit
67: foreign-object-factored fraction defective table storage unit
101: assembly order information
102: task motion information
103: surface-of-interest information
104: relative position information
105: gravity information
111: foreign-object-factored fraction defective table
201: assembly order input portion
202: task motion input portion
203: surface-of-interest input portion
204: relative position display portion
205: gravity direction display portion
206: fraction defective setting portion
207: gravity input portion
301: result display portion
302: measure display portion
1021: name column
1041: hand
1042: surface of interest
1043: child part
1044: mother part
1045: face
1046: work table

1. An evaluation apparatus for evaluating an assembly operation of assembling a processing apparatus including a plurality of parts, the evaluation apparatus comprising:
a data collector; and
a fraction defective calculator, wherein
the data collector
acquires a gravity information indicating a gravity direction,
acquires an assembly order information indicating an order of motion and assembly performed to each of the plurality of parts for each step included in the assembly operation (hereinafter, referred to as an assembling step),
acquires a task motion information indicating a task motion performed by an operator in the assembling step,
acquires a surface-of-interest information indicating a surface of interest in each of the plurality of parts, and
acquires a relative position information indicating a positional relation between a foreign object source and the part in the assembling step, and
the fraction defective calculator calculates a foreign-object-factored fraction defective indicating a risk that a foreign object from the foreign object source adheres to the surface of interest due to the task motion, based on the gravity information, the assembly order information, the task motion information and the relative position information.

2. The evaluation apparatus according to claim 1, wherein
the task motion information indicates the positional relation in the assembling step, and is a time series data divided by a predetermined time length.

3. The evaluation apparatus according to claim 1, wherein
the surface of interest is a cleaning surface that is a surface requiring a predetermined degree of cleanliness.

4. The evaluation apparatus according to claim 3, wherein
the data collector extracts the cleaning surface based on a dimension data of the processing apparatus in a state of being assembled and a cleaning surface determination condition that is a condition for determining the cleaning surface.

5. The evaluation apparatus according to claim 1, further comprising:
a database in which a fraction defective index is defined for each positional relation, wherein
the fraction defective calculator calculates the foreign-object-factored fraction defective for each surface of interest based on the fraction defective index.

6. The evaluation apparatus according to claim 5, wherein
the fraction defective calculator determines whether the positional relation is a predetermined positional relation or another positional relation other than the predetermined positional relation.

7. The evaluation apparatus according to claim 6, wherein
in the determination of the predetermined positional relation, ray tracing is used to determine whether a straight line extending perpendicularly from the surface of interest of the part collides with the foreign object source.

8. The evaluation apparatus according to claim 1, wherein
the fraction defective calculator sums up or combines by multiplication foreign-object-factored fraction defectives of respective surfaces of interest in a same assembling step.

9. The evaluation apparatus according to claim 1, wherein
the fraction defective calculator sums up or combines by multiplication foreign-object-factored fraction defectives of respective surfaces of interest in the assembly operation for a same surface of interest.

10. The evaluation apparatus according to claim 1, wherein
based on the foreign-object-factored fraction defective, the fraction defective calculator extracts an assembling step to be improved from assembling steps included in the assembly order information and assigns a priority to the assembling step.

11. An evaluation method for evaluating an assembly operation of assembling a processing apparatus including a plurality of parts, the evaluation method comprising:
acquiring a gravity information indicating a gravity direction;
acquiring an assembly order information indicating an order of motion and assembly performed to each of the plurality of parts for each step included in the assembly operation (hereinafter, referred to as an assembling step);
acquiring a task motion information indicating a task motion performed by an operator in the assembling step;
acquiring a surface-of-interest information indicating a surface of interest in each of the plurality of parts;
acquiring a relative position information indicating a positional relation between a foreign object source and the part in the assembling step; and
calculating a foreign-object-factored fraction defective indicating a risk that a foreign object from the foreign object source adheres to the surface of interest due to the task motion, based on the gravity information, the assembly order information, the task motion information and the relative position information.
